(19) United States
(12) Patent Application Publication
(10) Pub. No.: US 2016/0026372 A1
(43) Pub. Date: Jan. 28, 2016

(54) GRAPH-BASED APPROACH FOR DYNAMIC CONFIGURATION OF USER INTERFACES

(71) Applicants: Sunil Arvindam, Bangalore (IN); Gaurav Chadha, Delhi (IN); Ashok Veilumuthu, Tirunelveli (IN); Suresh Venkatasubramaniyan, Madurai/Tamilnadu (IN)

(72) Inventors: Sunil Arvindam, Bangalore (IN); Gaurav Chadha, Delhi (IN); Ashok Veilumuthu, Tirunelveli (IN); Suresh Venkatasubramaniyan, Madurai/Tamilnadu (IN)

(21) Appl. No.: 14/337,519

(22) Filed: Jul. 22, 2014

(51) Int. Cl. G06F 3/0484

(52) U.S. Cl. CPC G06F 3/04847; G06F 3/04842

(57) ABSTRACT

Implementations of the present disclosure include methods, systems, and computer-readable storage mediums for dynamically configuring a user interface for interacting with an application. Actions can include: receiving user input, the user input having been provided through the user interface; in response to receiving the user input, determining one or more expected user-actions based on a graph and the user input, the graph modeling user interactions with the application; obtaining one or more modifications based on the one or more expected user-actions; and transmitting instructions to modify the user interface based on the one or more modifications.

### BACKGROUND

Both the power and versatility of software applications continue to increase with the ever-rising demand for computer systems across various aspects of society. However, the utility of such high-powered applications is limited by the ability of the user to navigate them. The user interface is the domain where such interactions between the user and the software application take place. Thus, there is a continued need for innovative techniques to promote efficient user interfaces.

### SUMMARY

Implementations of the present disclosure include computer-implemented methods for using structured data provided as a graph to dynamically configure user interfaces for web-based applications, the methods being performed by one or more processors. In some implementations, methods include actions of: receiving user input, the user input having been provided through the user interface; in response to receiving the user input, determining one or more expected user-actions based on a graph and the user input, the graph modeling user interactions with the application; obtaining one or more modifications based on the one or more expected user-actions; and transmitting instructions to modify the user interface based on the one or more modifications.

These and other implementations can each optionally include one or more of the following features. Determining one or more expected user-actions may include generating the graph based on the user input. The one or more modifications may include at least one of: combining two or more elements of the user interface; rearranging two or more elements of the user interface; and constructing one or more new user-interface elements. The graph may include a node graph including: a plurality of nodes, each of the nodes representing a respective element of the user interface; and a plurality of edges, each of the edges connecting a respective pair of nodes and representing a sequential interaction by one or more users with the pair of nodes. The edges of the graph may include directed edges. The edges of the graph may include time-weighted edges. Determining one or more expected user-actions may include implementing a clustering technique on the node graph. The graph may correspond to previous interactions with the application by a user that provided the user input through the user interface. The graph may correspond to previous interactions with the application by a class of multiple users. A user that provided the user interface may be outside the class of multiple users. The user input may be provided during a previous user session, and transmitting instructions to modify the user interface may occur between user sessions. The user input may be provided during a current user session, and transmitting instructions to modify the user interface may occur in real time during the current user session as a user interacts with the application. The user interface may include a default user interface. The user interface may include a previously modified user interface. The application may include a stock trading application facilitating buying and selling of securities buy the user via the user interface. Determining one or more expected user-actions based on the graph may include accessing the graph via an in-memory database. The one or more modifications may include a first set of modifications, and the method may further include: providing a first modified user interface based on the first set of modifications; providing a second modified user interface based on a second set of modifications; and selecting, from the first and second modified user interfaces, a preferred user interface by implementing an A/B testing technique. The second set of modifications may be obtained based on the one or more expected user-actions.

The present disclosure also provides one or more non-transitory computer-readable storage media coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example system architecture in accordance with implementations of the present disclosure.

FIG. 2 depicts an example system for providing and using structured data for dynamically configuring user interfaces.

FIG. 3 depicts an example protocol in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

### DETAILED DESCRIPTION

Implementations of the present disclosure are generally directed to systems, methods, and computer readable media for dynamically configuring a graphical user interface (“GUI”). In various implementations, data describing user interactions (e.g., user input) with a GUI throughout one or more user sessions is leveraged. In some examples, a GUI for interacting with the application is modified based on the data. In some examples, a default GUI for interacting with the application is constructed based on the data. In some implementations, data is stored in computer-readable memory as a graph. In some examples, the graph models user interactions with the application during the one or more user sessions. In some implementations, the graph can be evaluated and analyzed to determine one or more expected user-actions. In some examples, a modified UI or a default UI for the application can be constructed based on expected user-actions (e.g., one or more actions that a user is expected to initiate using the GUI). In some examples, the resulting modified or default UI can be described as being constructed in accordance with perceived (or interpolated) user preferences.

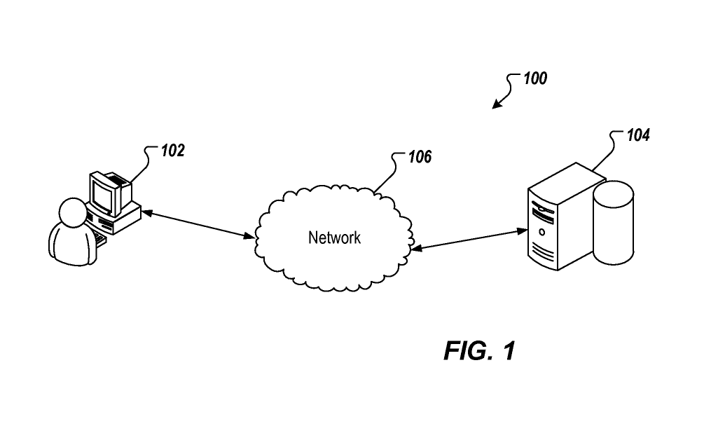

FIG. 1 depicts an example system architecture 100 in accordance with implementations of the present disclosure. The example system architecture 100 includes a client-side computing device (a client device) 102, a server-side computing device (a server device) 104 and a network 106. In general, the term “computing device” refers to any appropriate type of data processing device capable of running operating systems and application programs to perform server and/or client functions. Example computing devices can include a general-purpose personal computer (PC), Macintosh, workstation, UNIX-based workstation, a blade server, a handheld computer, a tablet computing device, a personal digital assistant (PDA), a smartphone, or any appropriate combination of any two or more of these data processing devices or other data processing devices.

The client device 102 can communicate with the server device 104 over the network 106. The network 106 can include a large computer network, such as a local area network (LAN), a wide area network (WAN), the Internet, a cellular network, or a combination thereof connecting any number of mobile computing devices, fixed computing devices and server systems. The server device 104 can include one or more computing devices and one or more machine-readable repositories, or databases.

For purposes of illustration, and as discussed in further detail below, a user can use the client device 102 to interact with a web-based application hosted by the server device 104. In some examples, the web application can be provided using one or more web pages of a web site that is hosted by the server device 104. In some examples, interaction between the client device 102 and the server device 104 includes executing a web browser on the client device 102 to display the one or more web pages. In some examples, the one or more web pages include user-interface elements such as dialogue boxes and clickable buttons that enable the user to provide input to the web page. For example, one or more GUIs can be displayed to the user, through which the user can interact with the web application.

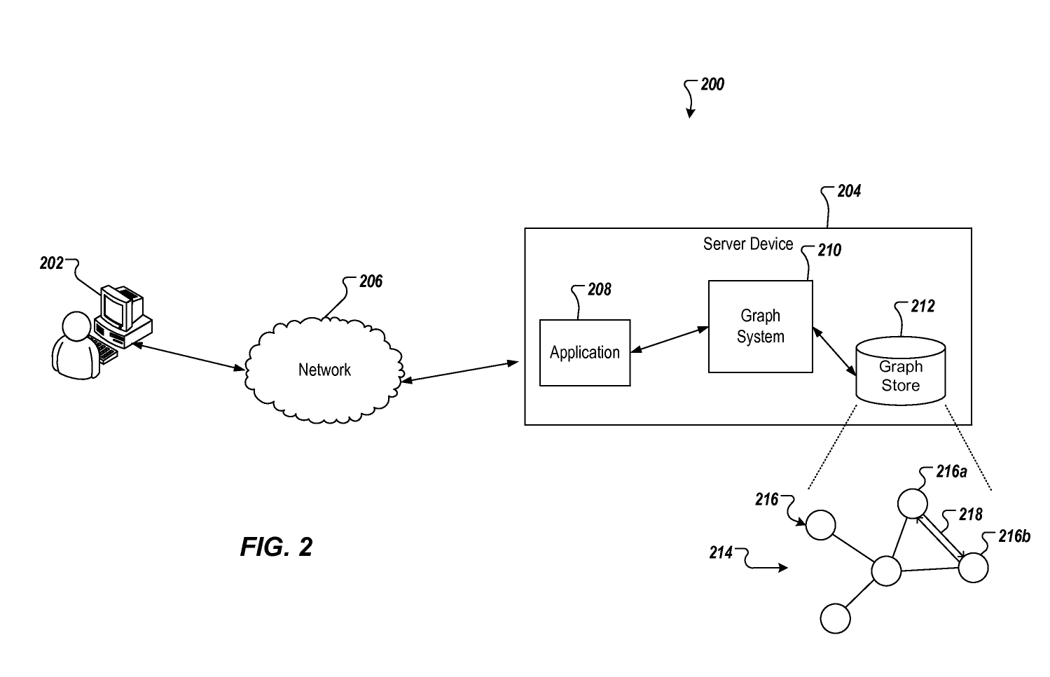

FIG. 2 depicts an example system 200 for providing and using structured data to dynamically configure user interfaces. As similarly described above with respect to the system architecture 100 of FIG. 1, the system 200 includes a client device 202 communicating with a server device 204 over a network 206. In this example, the server device 204 hosts a web application 208. That is, the server device 204 provides for storage and execution of the web application 208, and connectivity to the network 206, through which users of the client device 202 can access the web application. The server device 204 also includes a graph system 210 and a graph store 212. The web application 208 is communicatively linked with the graph system 210 (and vice versa); and the graph system 210 is communicatively linked with the graph store 212 (and vice versa).

For ease of understanding, implementations of the present disclosure will be described in view of various examples. In one example, the web application 208 is provided as a stock trading application designed to facilitate buying and selling of securities (e.g., stocks, bonds, and mutual funds). However, the present disclosure is not limited to this example context. In fact, it is contemplated that the systems, methods, and computer readable media described herein can be incorporated in any appropriate context involving a software application (either web-based or local software) that presents a user interface to a user through a client device.

Referring back to FIG. 2, the web application 208 includes a GUI that enables users to interact with the web application over the network 206 through the client device 202. The GUI for web application 208 can include a collection of UI elements that provide input and output functionality, for example. In some examples, input functionality enables users to manipulate the web application 208, while output functionality enables the web application to express the effect(s) of the users' manipulation. In some examples, UI elements can include textual and/or graphical UI elements. Textual UI elements can include text-based interfaces (e.g., text boxes) and windows for displaying text. Graphical UI elements can include selectable controls (e.g., menu bars, toolbars, and buttons) and windows for displaying still or moving graphics.

In some implementations, the GUI incorporates an arrangement of various UI elements intended to facilitate a “flow” of user interaction with the web application 208 that enables the user to perform desired tasks. For example, as a stock trading application, the UI of the web application 208 may include UI elements arranged to enable the user to interact with the application to buy and sell stocks. In some implementations, the UI for the web application 208 can include multiple pages of UI elements. The UI elements of each page, as well as the pages themselves, can enable user-interaction for the web application 208. For example, the UI of the stock trading web application 208 may include a Research Page and a Trading Page. The Research Page may present UI elements arranged for the user to accomplish stock research, while the Trading page present UI elements arranged for the user to accomplish stock trading. In this scenario, users may be presented first with the Research Page and then the Trading Page to facilitate a flow of user-interaction that leads to users buying and selling stocks.

User interaction with the UI of the web application 208 can be stored as data by the graph system 210 and stored in computer memory of the graph store 212. For example, each interaction with a UI element of the web application 208 can be recorded by the graph system 210 as user-interaction data. Such interactions may include, for example, interfacing with a UI element by mouse click, mouseover, scrolling, keyboard navigation or screen touch, and/or interfacing with a textual UI element by scrolling through or entering text. Any input from the user captured by the web application 208 through a GUI can be considered a “user interaction” as the term is used herein. Data describing user interactions can include data describing various characteristics of a user's interaction with a UI element. Such data can include, but is not limited to, one or more of the following: a user identifier, a session identifier, a time stamp, and a web application identifier.

Data describing user interactions with a GUI can be recorded for each session of activity (a “user session”) that a user conducts accessing the web application 208. A user session can be defined and parameterized in numerous ways. For example, a user session can be defined so as to begin when the user opens the web application 208 (e.g., the user logs into the web application) and end when the user closes the web application (e.g., the user logs out of the web application). In some examples, the user session ends at the expiration of a predetermined time period after the user opens the web application 208. In some examples, if the web application 208 is reopened during the time period, the user is still considered to be involved in the same user session. In some examples, the user session ends after a predetermined period of inactivity or lack of interaction with the web application 208. In some examples, the user session can be partitioned into multiple user sessions corresponding to activity on individual pages of the web-application UI. Of course, these examples are not intended to be limiting, and other definitions and parameters of a user session are also contemplated within the scope of the present disclosure.

Data describing user interactions with a GUI during a user session (“user-session data”) can be stored in computer-readable memory. In some examples, the data can be stored in the graph store 212 as a graph data structure, or graph 214. In this example, the graph 214 is a node graph. In some examples, the node graph 214 includes multiple nodes 216 and edges 218 between nodes. In some examples, each node 216 represents an action that a user can perform using a UI element included in a particular GUI. In some examples, each edge 218 represents a relationship between nodes 216. Pairs of nodes 216 in the graph are connected by edges 218. In some examples, the edges 218 are representative of a relationship including sequential user-interaction with the UI elements. For example, connected pairs of nodes in the node graph 214 can represent UI elements that are “adjacent” or “sequential” with respect to the user session. As one example in context of the stock trading application, a user may select a first UI element to show news relating to a particular stock; the user may then select a second UI element to show certain performance indicators relating to the stock. Accordingly, the node graph 214 includes a first node 216a, representing the first UI element, connected by an edge 218 to a second node 216b, representing the second UI element. In some implementations, the node graph 214 is a directed graph and each of the edges 218 is representative of an ordered-sequential interaction by the user with the node-represented UI elements. In the current example, if the user toggles from the first UI element to the second UI element and back again, the graph would include two directed edges connecting the first and second nodes 216a, 216b. In some implementations, edges 218 of the node graph 214 are weighted. In some examples, the weight indicates a strength of the relationship between the connected nodes. In some examples, the weight is determined based on a number of user interactions implicating the nodes. Continuing with the example above, if users across multiple user sessions consistently toggle the second UI element after toggling the first UI element, a first weight can be assigned to an edge 218 connecting the nodes 216a, 216b. However, if users across multiple user sessions infrequently toggle the second UI element after toggling the first UI element, a second weight can be assigned to an edge 218 connecting the nodes 216a, 216b, where the first weight is greater than the second weight. In some examples, weights can be provided based on time. For example, each edge carries a time-weight indicating the amount of time between user-interaction with the UI elements represented by paired nodes.

The node graph illustrated and described herein is provided as an example data structure; however other types of graphs (e.g., neural networks and decisions trees) may be used without departing from the scope of the present disclosure.

In some implementations, the node graph 214 corresponds to one or more user sessions with the web application 208 conducted by a single user. Accordingly, the graph store 212 can store numerous node graphs for respective users in computer-readable memory. In some implementations, the node graph 214 corresponds to one or more user sessions with the web application 208 conducted by multiple users. In some examples, multiple users can be grouped by class, with a respective node graph being generated and maintained for each class of users. As one example, users of the stock trading web application 208 may be classified as Day Traders or Casual Traders. Users in the Day Traders class would likely interact with a GUI of the web application 208 differently than users in the Causal Traders class. Thus, separate configurations of the GUI—and therefore separate node graphs—would be desirable. Classes for categorizing users can be developed with or without user input. As one example, users may voluntarily provide information to determine an applicable class.

In some implementations, the graph store 212 is operable to analyze the stored node graph 214 and provide data for a modified GUI. For example, the graph store 212 can employ a suitable graph clustering technique based on time-weights applied to the edges 218 between paired nodes 216 of the node graph 214 to provide data that can be used to modify a GUI. In particular, through the graph clustering technique, the graph store 212 may determine one or more expected user-actions, and can provide data indicating one or more expected (or next likely) user interactions. In some examples, the data can be provided to the graph system 210, which can provide modification data to the application 208. In some examples, the application 208 can provide a modified GUI based on the modification data. In some implementations, one or more modifications of the GUI can increase efficiency of a user's interaction with the web application 208, thereby improving the efficiency of resources (e.g., memory, processors) of the server device 204. Example modifications may include: combining or rearranging UI elements, combining or rearranging pages of UI elements and/or providing new UI elements not previously presented in the GUI.

In some implementations, efficiency with respect to user interaction with a GUI can be observed as the amount of resources (e.g., time or the number of user actions) spent by the user to accomplish a task enabled by the web application. Thus, in some examples, the graph system 210 is operable to provide modification data to the web application 208 based on one or more expected user actions determined by the graph store 212 that reduces or minimizes the amount of resources required to accomplish a specific task through the modified GUI.

In one example, during one or more user sessions with the web application 208, a user tends to select the second UI element for stock performance indicators soon after selecting the first UI element for stock news. Clustering of the resulting node graph 214 by the graph store 212 may identify one or more expected user-actions corresponding to this tendency and therefore determine that the user could more efficiently interface with the web application 208, if the GUI were modified to combine the first and second UI elements, or to move the first and second UI elements closer together within the GUI. In some examples, “expected user-actions” are defined as actions that the user is expected to perform using the GUI.

Note that, while the present example is described as employing a graph clustering technique for analyzing the node graph 214, any suitable technique for graph analysis can be used without departing from the scope of the present disclosure. Further, while the modified GUI in the present example includes a combination or moving of UI elements, other suitable techniques can also be used to increase user-efficiency. For example, modifying the GUI can include adding new UI elements, such as shortcuts or pop-up windows to assist the user in accomplishing a task more efficiently, and/or removing UI elements.

In some implementations, the graph system 210 together with the graph store 212 is operable to provide data for modifying a GUI at predetermined intervals. For example, data for modifying a GUI can be generated after a predetermined number of user sessions (e.g., one, ten or one-hundred user sessions) or after a predetermined amount of time (e.g., one, ten or one-hundred minutes). In this manner, any modification of the GUI is provided based on a sufficiently representative population. In some implementations, data can be provided for modifying a GUI in real-time. For example, a modified GUI can be generated between individual user actions. In some examples, to implement real-time modification of the GUI, user session data used to construct the graph stored in the graph store 212 may be provided from an in-memory database.

In some implementations, the GUI for the web application 208 can be modified over several iterations. In some examples, the graph store 212 updates the node graph 214 when new user-interaction data is provided by the graph system 210, and corresponding modifications to the GUI are determined based on the updated node graph. In some implementations, the graph store 212 treats each batch of user-interaction data as a separate node graph 214 for the current GUI. Accordingly, and in some examples, only the fresh node graph is analyzed to determine data for modifying the GUI.

In some implementations, the node graph 214 can be used to generate default GUIs for new users (e.g., users who have not yet conducted a user session). A default GUI for a new user can be generated by analyzing a node graph 214 corresponding to a user-class (e.g., a Day Traders class or a Casual Traders class) that the new user can be identified with. Thus, a default user can be presented initially with a GUI for the web application 208 that s/he is likely to efficiently interact with. The default GUI can be subsequently modified based on user sessions conducted by the new user according to the various techniques described above.

In some implementations, multiple default GUIs can be generated and used to employ an A/B testing technique for selecting a preferred GUI. The multiple default GUIs can be generated based on data provided by the graph store 212 using different node graphs (e.g., node graphs of different users or different classes of users) and/or different techniques for conducting graph analysis. In some implementations, an A/B testing technique includes generating first and second default GUIs; presenting the first default GUI to a first group of users and the second default GUI to a second group of users; monitoring user-interaction with the first and second GUIs; and selecting a preferred GUI as one of the first default GUI or the second default GUI. In some examples, the superior GUI can be determined based on a measured efficiency rating and/or user feedback.

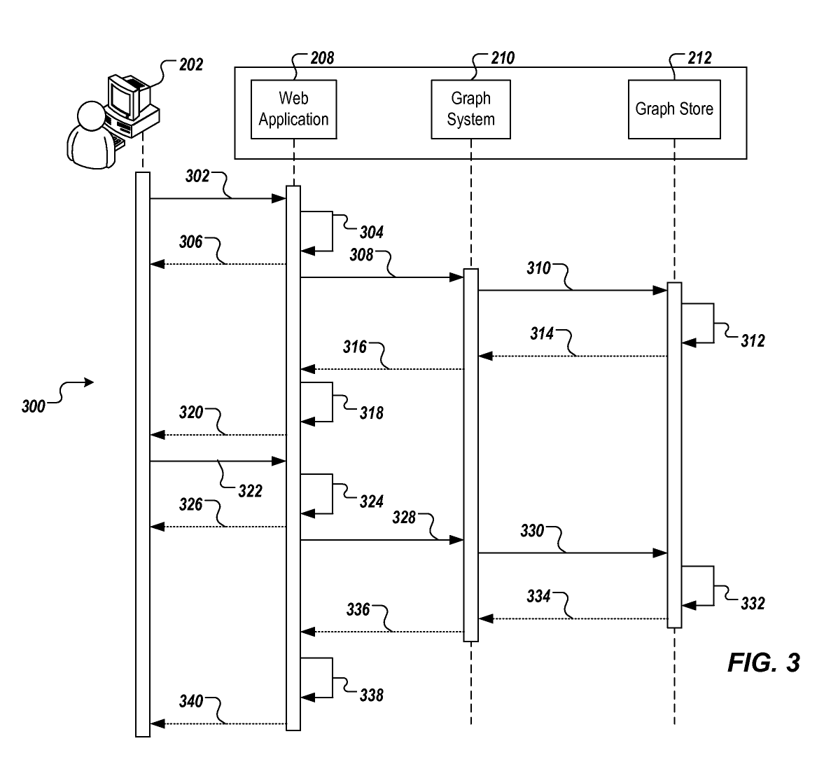

FIG. 3 depicts an example protocol 300 in accordance with implementations of the present disclosure. In the example of FIG. 3, a user operating the client device 202 interacts with the web application 208. For example, the user operates the client device 202 to conduct a first user session using a GUI of the stock trading web application 208 to buy and sell stocks. More specifically, the user provides (302) input to the web application 208 by interfacing with a GUI displayed on the client device 202. The web application 208 processes (304) the user-input (e.g., retrieving requested content relating to stocks and/or executing stock trading operations). In some examples, the web application 208 provides (306) output to the client device 202.

In some implementations, the web application 208 provides (308) user-interaction data corresponding to the user input to the graph system 210. The graph system 210 provides (310) the user-interaction data to the graph store 212. The graph store 212 analyzes (312) a graph corresponding to user interaction to provide (314) data indicating one or more next-likely user actions. In some examples, the graph store 212 updates an existing graph and/or provides a new graph based on the data received from the graph system 210. The graph system 210 can process the data from the graph store 212 to provide modification data. The graph system 210 provides (316) the modification data to the web application 208. The application 208 can provide (318) a modified GUI based on the modification data. In some examples, the web application 208 provides (320) instructions for displaying the modified GUI to the user on the computing device 202.

In some implementations, the user operates the client device 202 to conduct a second user session using the modified GUI. For example, the user provides (322) input to the web application 208 by interfacing with the modified GUI displayed on the client device 202. The web application 208 processes (324) the user input, and provides (326) output to the client device 202. In some implementations, the web application 208 provides (328) user-interaction data corresponding to the user input though the modified GUI to the graph system 210. The graph system 210 provides (330) the user-interaction data to the graph store 212. The graph store 212 analyzes (332) a graph corresponding to user interaction to provide (334) data indicating one or more next-likely user actions. The graph may be an updated graph corresponding to user interaction from both the first and second user session or a new graph corresponding to user interaction from only the second user session. The graph system 210 can process the data from the graph store 212 to provide modification data. The graph system 210 provides (336) the modification data to the web application 208. The application 208 can provide (338) a second modified GUI based on the modification data. In some examples, the web application 208 provides (340) instructions for displaying the second modified GUI to the user on the computing device 202.

While the example described in connection with FIG. 3 incorporated a piecemeal approach of modifying web-application UIs between user sessions, a similar technique can be accomplished with a real-time approach. For example, data corresponding to a single interaction by the user with the GUI of the web application 208, as opposed to an entire user session, could be communicated to the graph store 212 through the graph system 210. Thus, as noted above, the modified GUIs can be provided in real-time, between individual actions of the user.

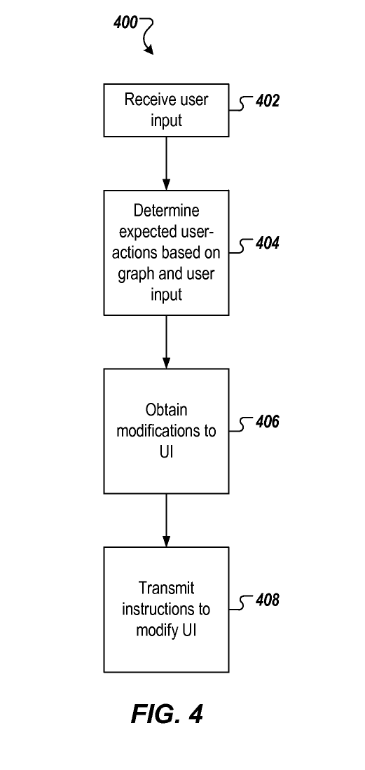

FIG. 4 depicts an example process 400 that can be executed in accordance with implementations of the present disclosure. In some implementations, the example process 400 can be realized using one or more computer-executable programs (e.g., a browser, a web application, a mobile application) executed using one or more computing devices (e.g., a client device, a server device).

According to the example process 400, user input is received (402). The user input can be provided through a GUI (e.g., a default user interface or a previously modified user interface) by a user operating a client device. In response to receiving the user input one or more expected user-actions are determined based on the user input and a graph corresponding to user interactions with the GUI (404). In some implementations, the graph can be analyzed to identify user preferences for interaction with the GUI. User preferences can be combined with the user input to determine one or more expected user-actions. In some implementations, determining expected user actions includes generating the graph based on the user input. In some implementations, the graph is a node graph including multiple nodes paired by edges, with the nodes representing respective UI elements and the edges representing a sequential interaction by one or more users with the pair of nodes. In some implementations, the graph corresponds to previous interactions with the application by the user that provided the user input. In some implementations, the graph corresponds to previous interactions with the GUI by a class of multiple users. One or more modifications to the GUI are obtained based on the expected user-actions (406). Instructions to modify the GUI based on the obtained modification are transmitted (408).

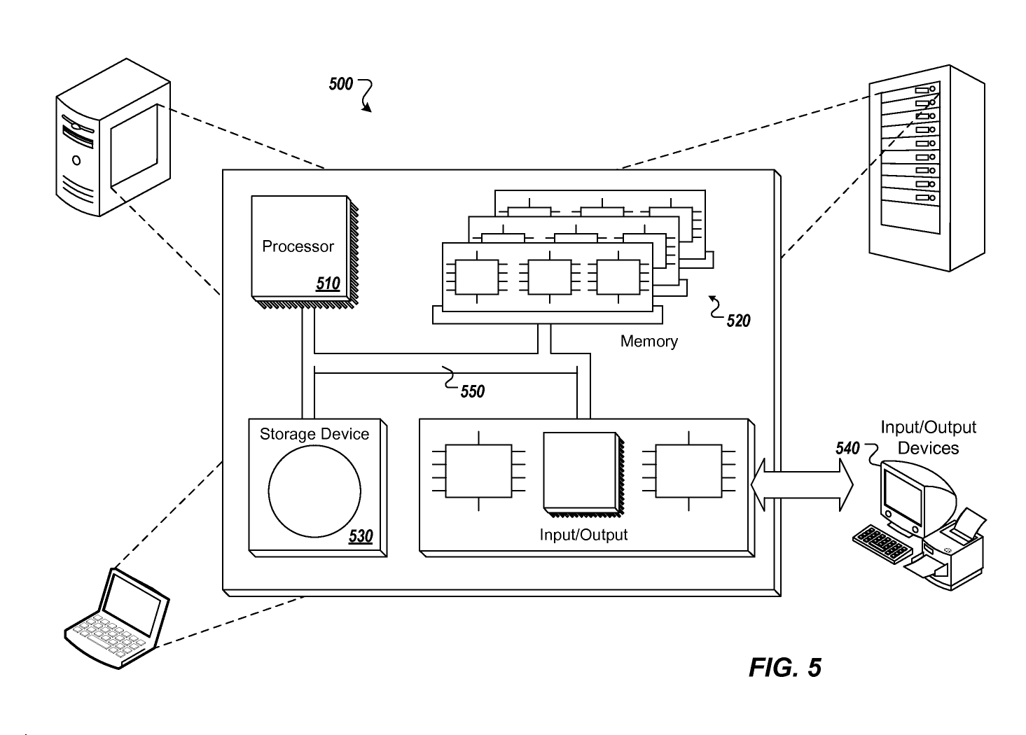

Referring now to FIG. 5, a schematic diagram of an example computing device 500 is provided. The device 500 can be used for the operations described in association with the implementations described herein. For example, the device 500 may be included in any or all of the server components discussed herein. The device 500 includes a processor 510, a memory 520, a storage device 530, and an input/output device 540. Each of the components 510, 520, 530, 540 are interconnected using a device bus 550. The processor 510 is capable of processing instructions for execution within the device 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the device 500. In one implementation, the memory 520 is a computer-readable medium. In one implementation, the memory 520 is a volatile memory unit. In another implementation, the memory 520 is a non-volatile memory unit. The storage device 530 is capable of providing mass storage for the device 500. In one implementation, the storage device 530 is a computer-readable medium. In various different implementations, the storage device 530 may be a floppy disk device, a hard disk device, an optical disk device, or a tape device. The input/output device 540 provides input/output operations for the device 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable device including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer device that includes a back-end component, such as a data server, or that includes a middleware component, such as an application server or an Internet server, or that includes a front-end component, such as a client computer having a graphical user interface or an Internet browser, or any combination of them. The components of the device can be connected by any form or medium of digital data communication such as a communication network. Examples of communication networks include, e.g., a LAN, a WAN, and the computers and networks forming the Internet.

The computer device can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for dynamically configuring a user interface for interacting with an application, the method being executed using one or more processors and comprising:
receiving, by the one or more processors, user input, the user input having been provided through the user interface;
in response to receiving the user input, determining, by the one or more processors, one or more expected user-actions based on a graph and the user input, the graph modeling user interactions with the application;
obtaining, by the one or more processors, one or more modifications based on the one or more expected user-actions; and
transmitting, by the one or more processors, instructions to modify the user interface based on the one or more modifications.

2. The method of claim 1, wherein determining one or more expected user-actions comprises generating the graph based on the user input.

3. The method of claim 1, wherein the one or more modifications comprise at least one of:
combining two or more elements of the user interface;
rearranging two or more elements of the user interface; and
constructing one or more new user-interface elements.

4. The method of claim 1, wherein the graph comprises a node graph comprising:
a plurality of nodes, each of the nodes representing a respective element of the user interface; and
a plurality of edges, each of the edges connecting a respective pair of nodes and representing a sequential interaction by one or more users with the pair of nodes.

5. The method of claim 4, wherein the edges of the graph comprise directed edges.

6. The method of claim 4, wherein the edges of the graph comprises time-weighted edges.

7. The method of claim 4, wherein determining one or more expected user-actions comprises implementing a clustering technique on the node graph.

8. The method of claim 1, wherein the graph corresponds to previous interactions with the application by a user that provided the user input through the user interface.

9. The method of claim 1, wherein the graph corresponds to previous interactions with the application by a class of multiple users.

10. The method of claim 9, wherein a user that provided the user interface is outside the class of multiple users.

11. The method of claim 1, wherein the user input was provided during a previous user session, and wherein transmitting instructions to modify the user interface occurs between user sessions.

12. The method of claim 1, wherein the user input was provided during a current user session, and wherein transmitting instructions to modify the user interface occurs in real time during the current user session as a user interacts with the application.

13. The method of claim 1, wherein the user interface comprises a default user interface.

14. The method of claim 1, wherein the user interface comprises a previously modified user interface.

15. The method of claim 1, wherein the application comprises a stock trading application facilitating buying and selling of securities by the user via the user interface.

16. The method of claim 1, wherein determining one or more expected user-actions based on the graph comprises accessing the graph via an in-memory database.

17. The method of claim 1, wherein the one or more modifications comprise a first set of modifications, and wherein the method further comprises:
providing a first modified user interface based on the first set of modifications;
providing a second modified user interface based on a second set of modifications; and
selecting, from the first and second modified user interfaces, a preferred user interface by implementing an A/B testing technique.

18. The method of claim 17, wherein the second set of modifications is obtained based on the one or more expected user-actions.

19. A non-transitory computer-readable storage medium coupled to one or more processors and having instructions stored thereon which, when executed by the one or more processors, cause the one or more processors to perform operations for dynamically configuring a user interface for interacting with an application, the operations comprising:
receiving, by the one or more processors, user input, the user input having been provided through the user interface;
in response to receiving the user input, determining, by the one or more processors, one or more expected user-actions based on a graph and the user input, the graph modeling user interactions with the application;
obtaining, by the one or more processors, one or more modifications based on the one or more expected user-actions; and
transmitting, by the one or more processors, instructions to modify the user interface based on the one or more modifications.

20. A system, comprising:
a client-side computing device; and
a computer-readable storage device coupled to the client-side computing device and having instructions stored thereon which, when executed by the client-side computing device, cause the client-side computing device to perform operations for dynamically configuring a user interface for interacting with an application, the operations comprising:
receiving, by the one or more processors, user input, the user input having been provided through the user interface;
in response to receiving the user input, determining, by the one or more processors, one or more expected user-actions based on a graph and the user input, the graph modeling user interactions with the application;
obtaining, by the one or more processors, one or more modifications based on the one or more expected user-actions; and
transmitting, by the one or more processors, instructions to modify the user interface based on the one or more modifications.
